(19) United States
(12) Patent Application Publication
(10) Pub. No.: US 2008/0083889 A1
(43) Pub. Date: Apr. 10, 2008

(54) Directly Fluid Operated Pinch Valve

(75) Inventor: Spiros G. Raftis, Pittsburgh, PA (US)

Correspondence Address: THE WEBB LAW FIRM, P.C., 700 KOPPERS BUILDING, 436 SEVENTH AVENUE, PITTSBURGH, PA, 15219, US

(73) Assignee: RED VALVE COMPANY, INC., Carnegie, PA (US)

(21) Appl. No.: 11/869,927

(22) Filed: Oct. 10, 2007

Related U.S. Application Data
(60) Provisional application No. 60/850,600, filed on Oct. 10, 2006.

(51) Int. Cl. F16K 7/07; F16K 7/02

(52) U.S. Cl. 251/5; 251/7

(57) ABSTRACT

A flow control pinch valve comprises a flexible outer sleeve and a flexible inner sleeve concentrically disposed within and spaced from the outer sleeve, wherein the inner sleeve defines a passageway for allowing fluid to pass therethrough. The sleeves are attached to each other at each end thereof and adapted to be attached to an inner surface of a fluid conduit. An annular space for receiving pressurized fluid is defined between the inner sleeve and the outer sleeve such that the inner sleeve is configured to deflect inwardly thereby controlling fluid flow through the passageway. A first clamping ring is concentrically disposed within the inner sleeve and the outer sleeve at one end; and a second clamping ring is concentrically disposed within the inner sleeve and the outer sleeve at an opposite end, wherein the clamping rings are used to secure the control valve within a pipe.

### CROSS REFERENCE TO RELATED APPLICATIONS

This application claims the benefit of U.S. Provisional Application No. 60/850,660, entitled “DIRECTLY FLUID OPERATED PINCH VALVE” filed on Oct. 10, 2006, which is hereby incorporated by reference.

### BACKGROUND OF THE INVENTION

1. Field of the Invention

The present invention relates generally to flow control valves, and in particular, to flow control valves used to control storm water, irrigation water or the like.

2. Description of Related Art

The present invention describes significant improvements to a prior art Pinch Valve as described in U.S. Pat. No. 4,268,005, which is hereby incorporated by reference. In many municipalities, heavy downpours of rain often result in street flooding and sewage treatment plant overload. The sewage treatment plants could be overloaded or flooded by short duration, heavy rainfall. During this rainfall, valves or gates must be closed, either partially or fully, to limit the flow of water into the processing plant. The flow restriction “backs up” the water in the upstream piping using the upstream piping to store some of this excess water. In some cases, the backed up water is diverted into a separate storage basin or chamber. When the heavy rainfall subsides, this stored water may be released under controlled conditions, by adjusting the valves or gates to achieve the desired, restricted flow. In other situations, storm sewer pipes may be overloaded and back up water into the streets that they are intended to drain.

Conventional prior art methods of controlling storm water influent typically use pinch valves. The prior art direct fluid operated pinch valves typically use a flexible member or “sleeve” enclosed in a rigid pressure containing body or housing. The valves are installed between an upstream section and downstream section of pipe using end flanges, or similar attaching devices. The space between the rigid outer housing and the inner sleeve is pressurized with air or other fluid to squeeze the inner sleeve to control flow through the valve.

It is, therefore, an object of the present invention to provide a low cost, fully functional valve that does not require a separate rigid body (housing) or end flanges, either on the valve or on the mating piping and prevents the back up of sewer water.

### SUMMARY OF THE INVENTION

The present invention provides a directly fluid operated flow control pinch valve that is inserted into a pipe and fastened into position using clamps, bolts and nuts, or other similar suitable methods. The valve, which may be positioned to separate an upstream fluid flow and a downstream fluid flow, includes a flexible hollow cylindrical outer sleeve; and a flexible hollow cylindrical inner sleeve concentrically disposed within and spaced from the outer sleeve, wherein the sleeves are attached to each other at each end thereof and adapted to be attached to an inner surface of a fluid conduit. The inner sleeve defines a passageway for allowing fluid to pass therethrough, and an annular space for receiving pressurized material is defined between the inner sleeve and the outer sleeve such that the inner sleeve is configured to deflect inwardly thereby controlling fluid flow through the passageway. The valve further includes end clamps with mounting hardware (i.e., bolts, washers and nuts) positioned within the sleeves and at least one opening having a fitting fluidly connected thereto to allow the introduction and exhaust of pressurized gas within the space between the outer sleeve and the inner sleeve (or other suitable fluid) to operate the valve. The pipe is used to provide mechanical reinforcement to the outer sleeve which contains the operating fluid pressure. The inner sleeve is used to control fluid flow in the pipeline. During normal low flow conditions, the valve is fully open and provides negligible restriction to storm water flow. During heavy rainfall, pressurized air may be introduced into the space between the inner and outer sleeves, via the air fitting, such that the inner sleeves constrict thus moderating the flow of fluid through the pipe. The outer sleeve does not constrict and is restrained by the pipe wall.

The present invention, both as to its construction and its method of operation, together with the additional objects and advantages thereof, will best be understood from the following description of exemplary embodiments when read in connection with the accompanying drawings.

### BRIEF DESCRIPTION OF THE DRAWINGS

FIG. 1A is a perspective view of a first embodiment of a flow control valve according to the present invention;

FIGS. 1B and 1C show perspective views of end clamps used to secure the first embodiment of the valve shown in FIG. 1A within a pipeline;

FIG. 2A is a perspective view of a second embodiment of a flow control valve according to the present invention;

FIGS. 2B and 2C show perspective views of end clamps used to secure the second embodiment of the valve shown in FIG. 2A within a pipeline;

FIG. 3A is a side sectional view of the first embodiment of the flow control valve shown in FIG. 1A installed in a pipeline with the valve fully open and normal flow through the pipeline;

FIG. 3B is an elevational end view of the first embodiment of the flow control valve shown in FIG. 3A;

FIG. 4A is a side sectional view of the first embodiment of the flow control valve shown in FIG. 3A with the valve partially closed and restricting potential increased flow through the pipeline;

FIG. 4B is an elevational end view of the first embodiment of the flow control valve shown in FIG. 4A;

FIG. 5A is a side sectional view of the first embodiment of the flow control valve shown in FIG. 3A with the valve fully closed and blocking all flow through the pipeline;

FIG. 5B is an elevational end view of the first embodiment of the flow control valve shown in FIG. 5A;

FIG. 6A is a side sectional view of the second embodiment of the flow control valve shown in FIG. 2A installed in a pipeline with the valve fully open and normal flow through the pipeline;

FIG. 6B is an elevational end view of the second embodiment of the flow control valve shown in FIG. 6A;

FIG. 7A is a side sectional view of the second embodiment of the flow control valve shown in FIG. 6A with the valve partially closed and restricting potential increased flow through the pipeline;

FIG. 7B is an elevational end view of the second embodiment of the flow control valve shown in FIG. 7A;

FIG. 8A is a side sectional view of the second embodiment of the flow control valve shown in FIG. 6A with the valve fully closed and blocking all flow through the pipeline;

FIG. 8B is an elevational end view of the second embodiment of the flow control valve shown in FIG. 8A;

FIG. 9A is an elevational end view of a third embodiment of a flow control valve according to the present invention installed in a pipeline with the valve fully open and normal flow through the pipeline;

FIG. 9B is a side sectional view of the flow control valve shown in FIG. 9A taken along lines IX-IX;

FIG. 10A is an elevational end view of the third embodiment of the flow control valve shown in FIG. 9A with the valve partially closed and restricting potential increased flow through the pipeline;

FIG. 10B is a side sectional view of the flow control valve shown in FIG. 10A taken along lines X-X;

FIG. 11A is an elevational end view of the third embodiment of the flow control valve shown in FIG. 9A with the valve fully closed and blocking all flow through the pipeline;

FIG. 11B is a side sectional view of the flow control valve shown in FIG. 11A taken along lines XI-XI;

FIG. 12A is an elevational end view of a fourth embodiment of a flow control valve according to the present invention installed in a pipeline with the valve fully open and no flow through the pipeline;

FIG. 12B is a side sectional view of the flow control valve shown in FIG. 12A taken along lines XII-XII;

FIG. 13A is an elevational end view of the fourth embodiment of the flow control valve shown in FIG. 12A with the valve fully closed and blocking all flow through the pipeline; and

FIG. 13B is a side sectional view of the flow control valve shown in FIG. 13A taken along lines XIII-XIII.

### DETAILED DESCRIPTION OF THE PREFERRED EMBODIMENTS

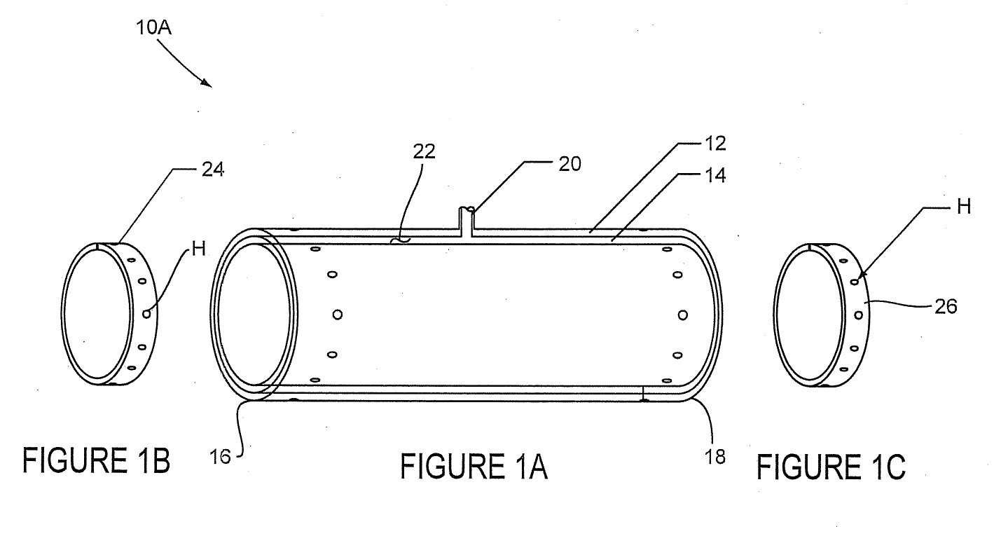

A first embodiment of a flow control valve 10A of the present invention is generally shown in FIGS. 1A-C. The first embodiment of the flow control valve 10A is particularly adapted to be used in a pipeline, for example, a storm water drainage pipeline or a combined sanitary and storm water influent pipe to a sewage treatment plant. The flow control valve 10A includes a flexible outer cylindrical sleeve 12 and a flexible inner cylindrical sleeve 14 concentrically disposed within and spaced from the outer sleeve 12. The control valve 10A having a first end 16 and a second end 18 includes at least one fitting 20, such as an air fitting, defined in the outer sleeve 12 for allowing the introduction and exhaust of air (or other suitable fluid) within an annular space 22 between the inner sleeve 14 and the outer sleeve 12.

Referring to FIGS. 1A-C and 3A, the control valve 10A further includes a first clamping ring 24 concentrically disposed within the inner sleeve 14 adjacent the first end 16, and a second clamping ring 26 concentrically disposed within the inner sleeve 14 adjacent the second end 18. The clamping rings 24, 26 are used for installing the control valve 10A directly inside a pipe 28.

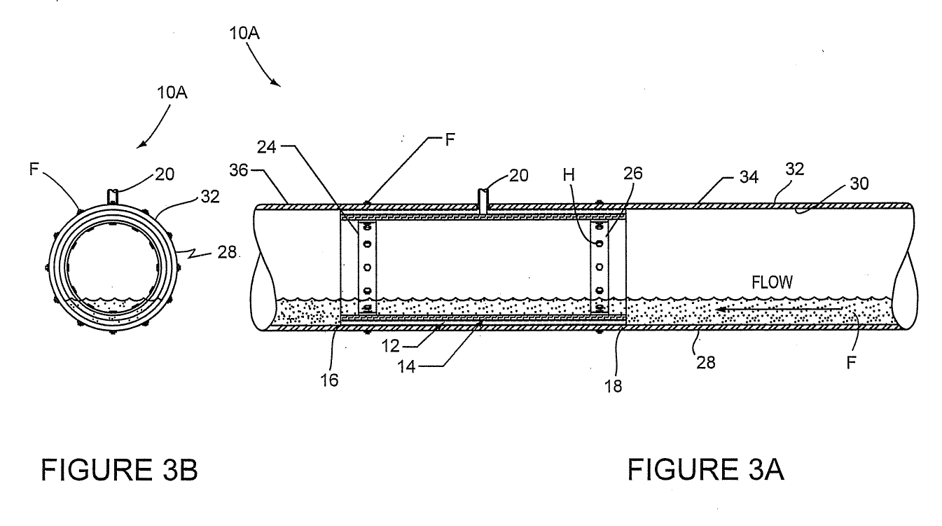

Referring to FIGS. 3A-B, the control valve 10A is positioned inside the pipe 28 having an inner surface 30 and an outer surface 32, essentially separating the pipe 28 into an upstream pipeline 34 and a downstream pipeline 36. Bolt holes H are defined in the clamping rings 24, 26, wherein the clamping rings 24, 26 are fastened to the inside of the pipe 28 using a fastening arrangement F, such as a nut, bolt and washer arrangement. For example, during installation a bolt passes through the bolt hole H in each of the clamping rings 24, 26, the inner and outer sleeves 12, 14 and the pipe 28. A nut having a washer is then fastened to the bolts and tightened to the outer surface 32 of the pipe 28. Depending on the type fastening arrangement used and the clearance between the bolts and the bolt holes H, a caulking or sealing compound may be required to provide a leak-tight seal between the outer sleeve 12 and the inner surface 30 of the pipe 28. It is also important that a leak-tight seal be accomplished between the inner sleeve 14 and the outer sleeve 12 to contain the operating air pressure. This may be accomplished either by (1) bonding the first end 16 and the second end 18 of the sleeves 12, 14 during the manufacturing process or, (2) relying on the clamping forces between the clamps 24, 26 and the pipe 28 to achieve the leak-tight seal.

In operation, the fitting 20 extends through the pipe 28 and is adapted to be fluidly connected to an external pressurized fluid or air source. The fitting 20 may be integral with the outer sleeve 12 or, a separate metal or plastic fitting may be bonded to the outer sleeve 12. The outer and inner sleeves 12, 14 may be made from an elastomeric material such as neoprene and may be reinforced with a fabric such as nylon or polyester. The clamping rings 24, 26 may be made of a metallic material such as steel or stainless steel. The pipe 28 preferably has a circular cross section, but may also have an elliptical, oval or square cross section. The pipe 28 may be made of any common materials used for storm water containment, for example, plastic, cast iron, steel, reinforced concrete and the like.

In operation, operating air pressure is supplied to the fitting 20 and is used to deflect or to deform the inner sleeve 14 inward as shown in FIG. 3A. The outer sleeve 12 is restrained by the inner surface 30 of the pipe 28. The inner sleeve 14 typically deflects in a three lobe configuration. For example, valves in the 30-inch to 84-inch diameter size range require pressure ranging between 3 to 10 psi above the pipeline pressure to completely close the valve and shut off the flow.

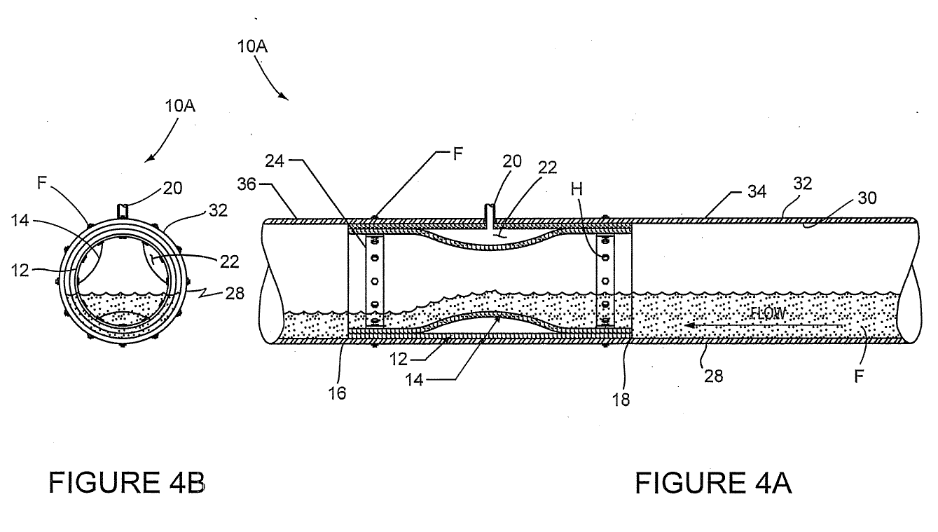

As seen in FIG. 3A, during a normal flow period, the control valve 10A is fully open and fluid passes from the upstream pipeline 34 through the control valve 10A into the downstream pipeline 36 with little or no interruption in fluid flow. However, as shown in FIGS. 4A and 4B, during sudden, increased flow conditions, the valve 10A may be pressurized through a fitting 20 to partially close the valve 10A. For example, a pressurized gas is introduced in the space 22 between the outer sleeve 12 and the inner sleeve 14 via the fitting, so that the inner sleeve 14 is inwardly deformed to partially pinch and curtail the flow of fluid F through the valve 10A. This partial closing of the valve 10A restricts the passage of instantaneous high volume of water through the pipe 28, thus preventing overloading and flooding downstream, and backing up and storing the excess water for future controlled release.

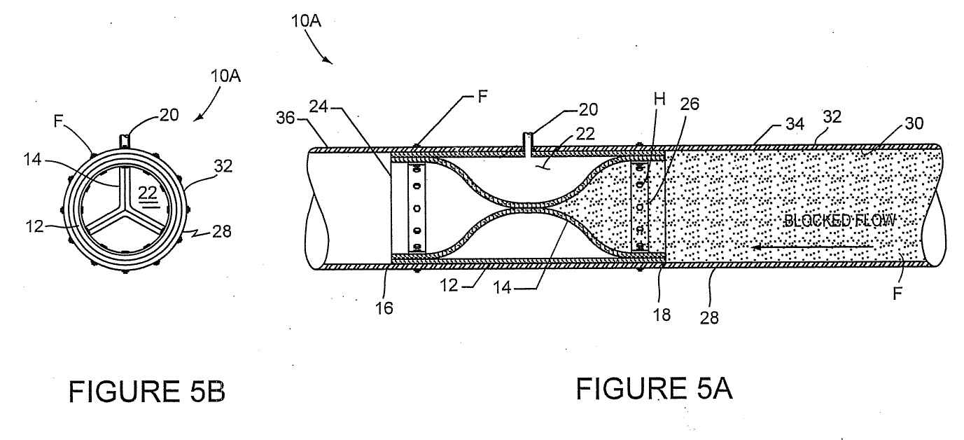

FIGS. 5A-B illustrates the operation of the flow control valve 10A during periods of increased or maximum flow conditions. To fully close the control valve 10A, the inner sleeve 14 is inwardly deformed to totally pinch and prevent fluid F from being released to the downstream pipeline 36. The upstream pipeline 34 becomes a storage area for the fluid F, which may later be slowly released as treatment plant capacity becomes available.

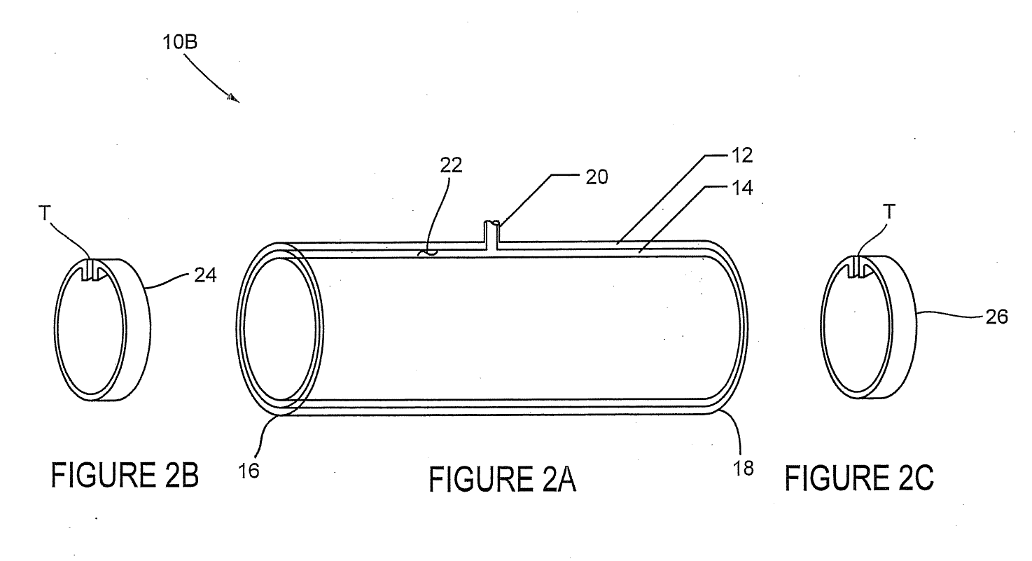

FIGS. 2A-C show a second embodiment of a flow control valve 10B of the present invention as similar to control valve 10A. Like reference numerals are used for like parts. In this embodiment, the clamping rings 24, 26 of the flow control valve 10A are replaced with expansion clamps 40, 42, respectively, which do not require drilling through the pipe 28 in order to secure the control valve 10B within the pipe 28. The clamps 40, 42 are disposed on respective ends 16, 18 of the control valve 10B and are expanded by using a turnbuckle T, or the like, and secured in position within the control valve 10B via friction fit. Installation methods for this embodiment of the invention will be readily apparent to those skilled in the art. The use of the expansion clamps 40, 42 are generally suitable with reinforced concrete pipe.

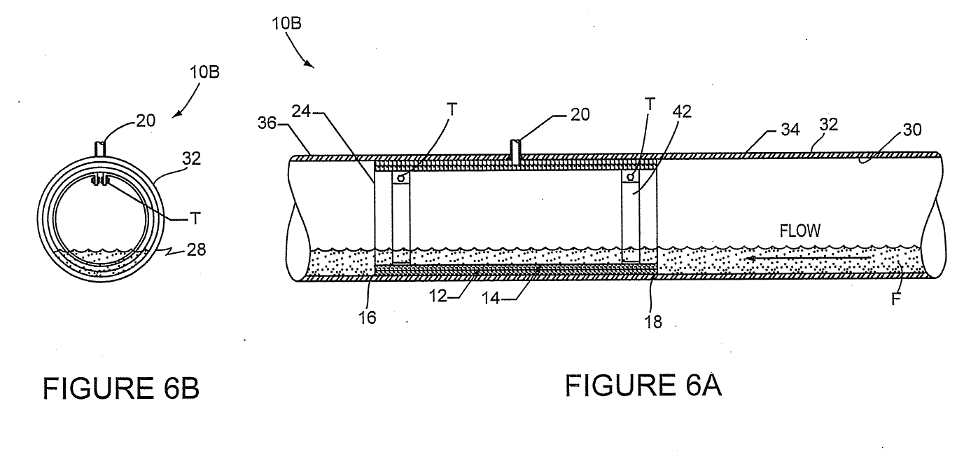

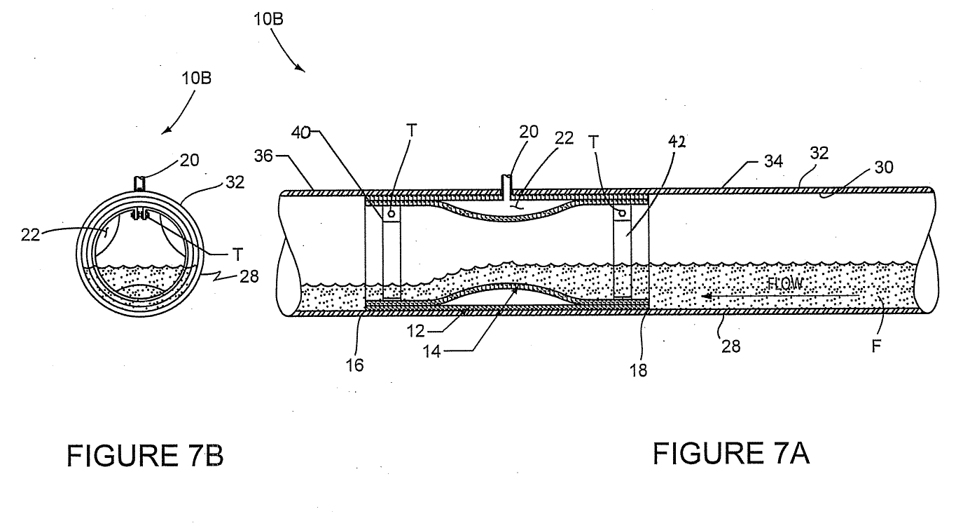

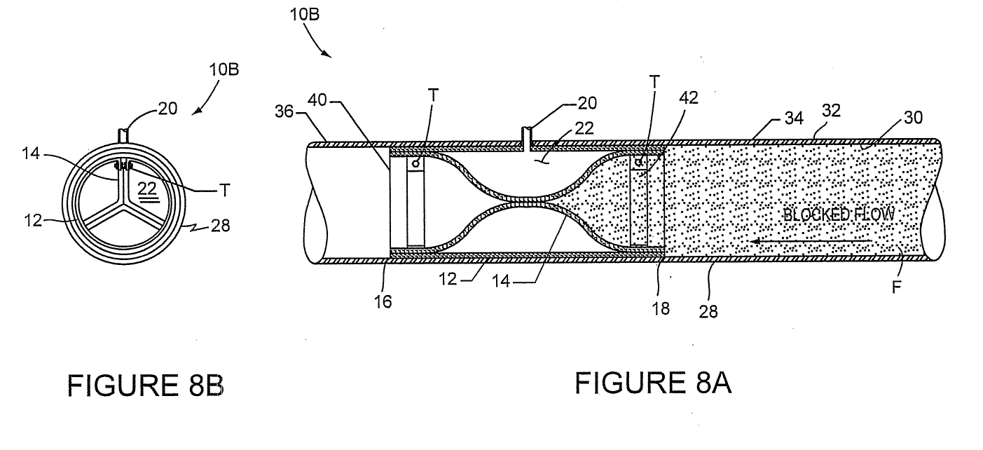

FIGS. 6A-B, 7A-B and 8A-B illustrate the operation of the flow control valve 10B during normal flow periods with the valve 10B fully open, increased flow conditions with the valve partially closed and maximum flow conditions with the valve fully closed, respectively. The overall flow characteristics of this embodiment are not changed from those of the first embodiment of the present invention.

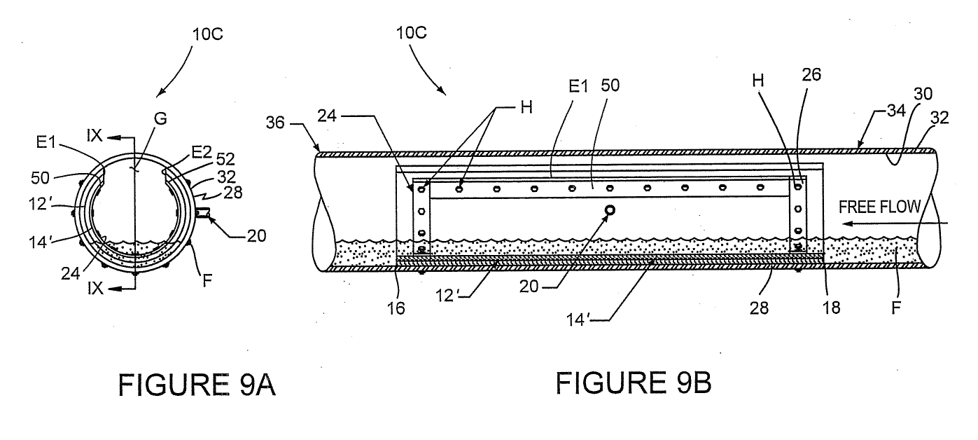

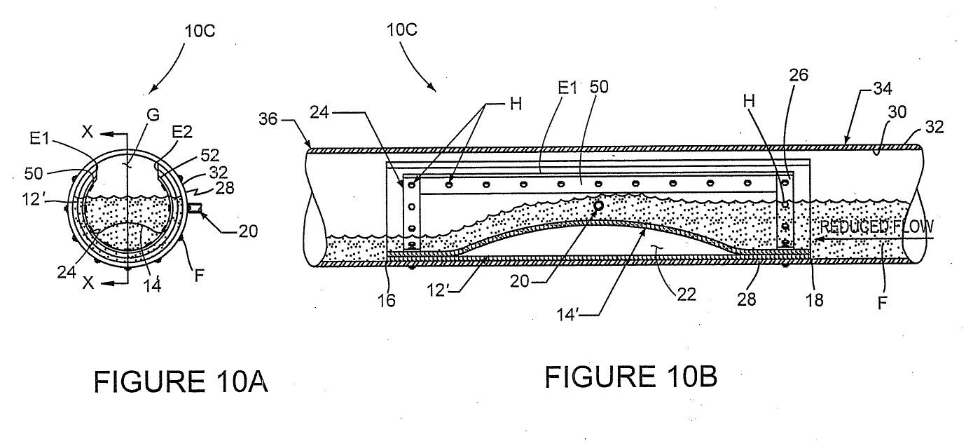

FIGS. 9A-B, 10A-B and 11A-B show a third embodiment of a flow control valve 10C of the present invention is similar to control valve 10A, except for the differences noted below. Like reference numerals are used for like parts. Instead of the control valve 10A having cylindrical sleeves 12, 14, the control valve 10C includes two overlapping flexible rectangular sleeves 12′, 14′ spaced from each other and disposed within a pipe 28. The rectangular sleeves 12′, 14′ do not fully encircle the inside circumference of the pipe 28, thereby leaving a gap or exposed portion G between each open end E1, E2 of the sleeves 12′, 14′ as shown in FIGS. 9A, 10A and 11A. For example, sleeves 12′, 14′ may extend approximately 65% of the inside circumference of the pipe 28.

Referring to FIGS. 9B, 10B and 11B, the control valve 10C having a first end 16 and a second end 18 includes at least one fitting 20, such as an air fitting, defined in the outer sleeve 12′ for allowing the introduction and exhaust of air (or other suitable fluid) within an annular space 22 between the inner sleeve 14′ and the outer sleeve 12′. A first open clamping ring 24 is disposed within the inner sleeve 14′ adjacent the first end 16, and a second open clamping ring 26 is disposed within the inner sleeve 14′ adjacent the second end 18. A first clamping bar 50 is disposed within the inner sleeve 14′ adjacent a first open end E1 and extends from the first clamping ring 24 to the second clamping ring 26. A second clamping bar 52 is also disposed within the inner sleeve 14′ adjacent a second open end E2 (not shown) and extends from the first clamping ring 24 to the second clamping ring 26. Bolt holes H are defined in the clamping bars 50, 52, wherein the clamping bars 50, 52 are fastened to the inside of the pipe 28 using a fastening arrangement F, such as a nut, bolt and washer arrangement. The open clamping rings 24, 26 and clamping bars 50, 52 are used for installing the control valve 10C directly inside a pipe 28.

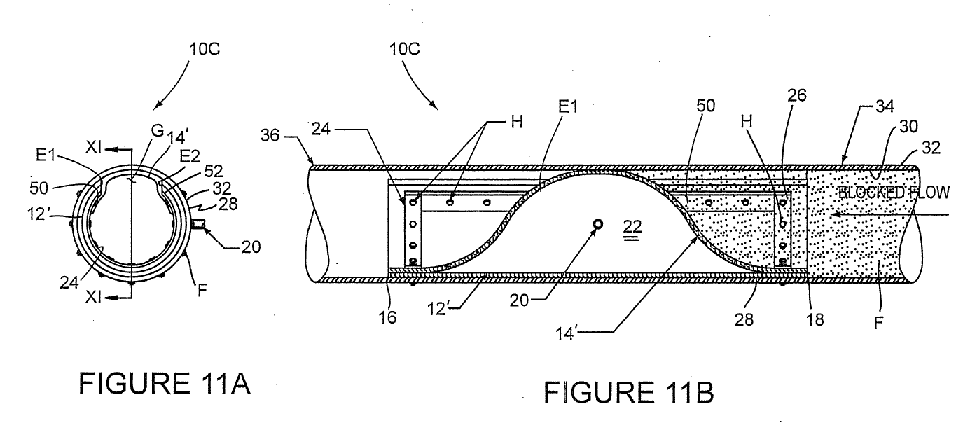

Referring to FIGS. 9A-B and 10A-B, the operation and the overall flow characteristics during normal flow periods (valve 10C fully open) and increased flow conditions (valve 10C partially closed), respectively, are substantially the same as those of the first embodiment of the present invention. However, in the maximum flow conditions (valve 10C fully closed) as shown in FIGS. 11A-B, the inner sleeve 14′ is inwardly deformed and extends within the gap portion G to the inner surface 30 of the pipe 28 to totally pinch and prevent fluid F from being released to the downstream pipeline 36. The flow control valve 10C is particularly adapted to be used in a pipeline, for example, a storm-water drainage pipeline or combined sanitary and storm water influent pipe to a sewage treatment plant.

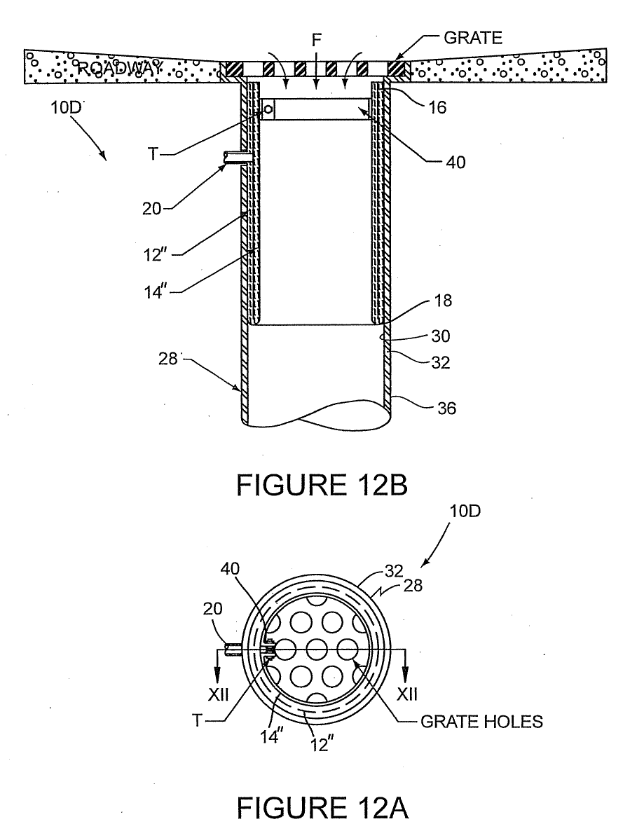

A fourth embodiment of a flow control valve 10D of the present invention is generally shown in FIGS. 12A-B and 13A-B. The flow control valve 10D is particularly adapted to be used in a drainpipe, for example, a storm water drainage from a roadway or parking lot, to prevent back flow of storm water. The flow control valve 10D is similar to control valve 10B, except for the differences noted below. Like reference numerals are used for like parts. The flow control valve 10D includes a flexible outer cylindrical sleeve 12″ and a flexible inner cylindrical sleeve 14″ concentrically disposed within and spaced from the outer sleeve 12. The sleeves 12″, 14″ having a first end 16 and a second end 18 include at least one fitting 20, such as an air fitting, defined in the outer sleeve 12 for allowing the introduction and exhaust of air (or other suitable fluid) within an annular space 22 between the inner sleeve 14 and the outer sleeve 12. Only one clamping ring 40 concentrically disposed within the inner sleeve 14″ at the first end 16 is used for installing the control valve 10D directly inside a pipe 28. The inner and outer sleeves 14″, 16″ are attached to each other at the second end. The sleeves 12″, 14″ may be bonded, clamped or fabricated seamlessly together at the second end 18 thereof.

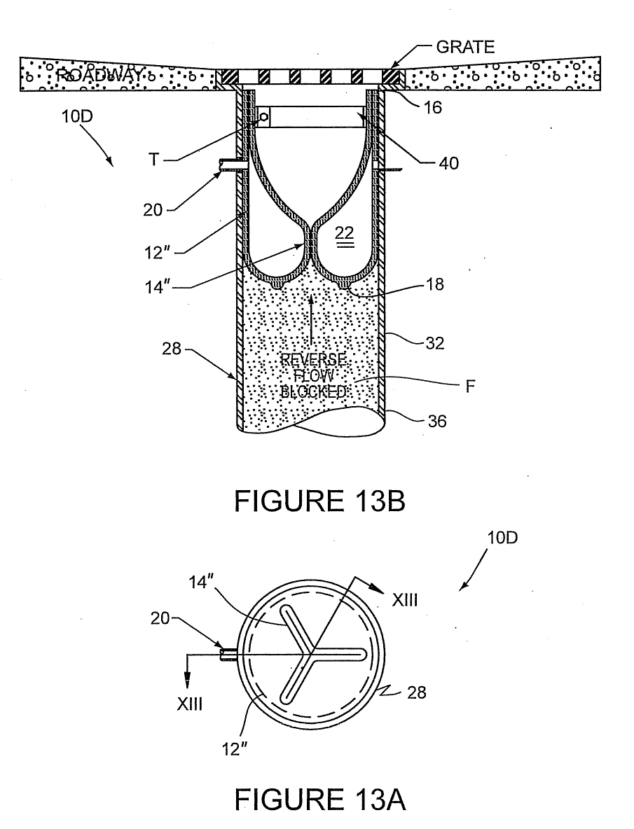

FIGS. 12B and 13B show the operation and the overall flow characteristics during normal flow periods (valve 10D fully open) and maximum flow conditions (valve 10D fully closed), respectively, which are substantially the same as those of the first embodiment of the present invention. However, when flow control valve 10D is in the fully closed position as shown in FIGS. 13A-B, the outer sleeve 16″ is restrained by the pipe wall for part of its length. By introducing air pressure through the fitting 20, the inner sleeve 14″ is deflected inward and pulls part of the second end 18 of the outer sleeve 16″ with it, such that the inner sleeve 14″ deflects into a three lobed configuration thus fully closing the valve 10D as shown in FIG. 13A.

This invention has been described with reference to the preferred embodiments. Obvious modifications and alterations will occur to others upon reading and understanding the preceding detailed description. It is intended that the invention be construed as including all such modifications and alterations.

I claim:

1. A flow control pinch valve, comprising:
a flexible outer sleeve; and
a flexible inner sleeve concentrically disposed within and spaced from said outer sleeve, said sleeves attached to each other at each end thereof and adapted to be attached to an inner surface of a fluid conduit, wherein said inner sleeve defines a passageway for allowing fluid to pass therethrough, and wherein an annular space for receiving pressurized material is defined between said inner sleeve and said outer sleeve such that said inner sleeve is configured to deflect inwardly thereby controlling fluid flow through the passageway.

2. The flow control pinch valve of claim 1, further comprising a clamping member positioned at each end of said sleeves, said clamping members adapted to attach the ends of said sleeves to each other when said sleeves are attached to an inner surface of a fluid conduit.

3. The flow control pinch valve of claim 2, wherein said clamping members comprise a first clamping ring concentrically disposed within said inner sleeve adjacent to one end, and a second clamping ring concentrically disposed within said inner sleeve adjacent to an opposite end thereof, wherein said clamping rings are adapted to attach the ends of said sleeves to each other when said clamping rings are attached to an inner surface of a fluid conduit.

4. The flow control pinch valve of claim 3, wherein said clamping rings are adapted to mechanically attach to the inner surface of the fluid conduit such that said outer sleeve is restrained by the inner surface of the fluid conduit when the inner sleeve is deflected.

5. The flow control pinch valve of claim 2, wherein said clamping members comprise a first expansion ring concentrically disposed within said inner sleeve adjacent to one end, and a second expansion ring concentrically disposed within said inner sleeve adjacent to an opposite end thereof, wherein said expansion rings are adapted to attach the ends of said sleeves to each other when said expansion rings are attached to an inner surface of a fluid conduit.

6. The flow control pinch valve of claim 5, wherein said expansion rings are adapted to frictionally attach to the inner surface of the fluid conduit such that said outer sleeve is restrained by the inner surface of the fluid conduit when the inner sleeve is deflected.

7. The flow control pinch valve of claim 1, wherein at least one opening is defined on said outer sleeve for allowing the introduction and exhaust of pressurized material within the annular space, the opening having a fitting fluidly connected thereto extends laterally away from said outer sleeve, wherein said fitting is adapted to be fluidly connected to an external pressurized source.

8. The flow control pinch valve of claim 1, wherein said sleeves are geometric shaped.

9. The flow control pinch valve of claim 8, wherein said sleeves correspond to the shape of the fluid conduit.

10. The flow control pinch valve of claim 8, wherein said sleeves are cylindrical shaped.

11. The flow control pinch valve of claim 7, wherein said fitting is integrally formed with said outer sleeve.

12. The flow control pinch valve of claim 1, wherein said sleeves are made of an elastomeric material.

13. The flow control pinch valve of claim 1, wherein said sleeves are made of a fabric reinforced elastomeric material.

14. The flow control pinch valve of claim 1, wherein each end of said sleeves are integrally attached to each other.

15. The flow control pinch valve of claim 1, wherein each end of said sleeves are fabricated seamlessly to each other.

16. The flow control pinch valve of claim 1, further comprising a clamping member positioned at an end of said sleeves, said clamping member adapted to attach said sleeves to an inner surface of a fluid conduit.

17. The flow control pinch valve of claim 1, wherein the pressurized material comprises air or water.

18. A flow control valve, comprising:
a fluid conduit
a first flexible sleeve;
a second flexible sleeve overlapping and spaced from said first sleeve, wherein an annular space for receiving pressurized fluid is defined between said first sleeve and said second sleeve, said sleeves received within said fluid conduit such that said sleeves partially encompass an inner surface of said fluid conduit thereby defining an exposed portion, wherein said sleeves and the exposed portion define a passageway for allowing fluid to pass through said fluid conduit;
an open clamping member disposed within the fluid conduit and attached at each end of said sleeves; and
at least one clamping bar extending between each open clamping member adjacent to the exposed portion of said fluid conduit, wherein said open clamping members and said clamping bar are used to secure the control valve within said fluid conduit such that said second sleeve is configured to deflect toward the exposed portion thereby controlling fluid flow through the passageway.

19. The flow control valve of claim 18, further comprising a pair of spaced apart clamping bars extending between each open clamping member adjacent to the exposed portion of said fluid conduit.

20. A flow control valve, comprising:
a flexible outer sleeve;
a flexible inner sleeve concentrically disposed within and spaced from the outer sleeve, the outer sleeve attached to the inner sleeve at one end, wherein an annular space for receiving pressurized fluid is defined between the inner sleeve and the outer sleeve; and
a clamping ring concentrically disposed within the inner sleeve and the outer sleeve at an opposite end, wherein the clamping ring is used to secure the control valve within a pipe.
